(19) United States
(12) Patent Application Publication
(10) Pub. No.: US 2008/0012818 A1
(43) Pub. Date: Jan. 17, 2008

(54) SHIFT REGISTER, DISPLAY DEVICE INCLUDING SHIFT REGISTER, METHOD OF DRIVING SHIFT REGISTER AND METHOD OF DRIVING DISPLAY DEVICE

(75) Inventors: Myung-Woo LEE, Seoul (KR); Sang-Jin PAK, Yongin-si (KR); Kee-Han UH, Yongin-si (KR); Joo-Hyung LEE, Gwacheon-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/622,737

(22) Filed: Jan. 12, 2007

(30) Foreign Application Priority Data
Jul. 11, 2006 (KR) 10-2006-0064675

(51) Int. Cl. G09G 3/36

(52) U.S. Cl. 345/100

(57) ABSTRACT

A shift register includes a plurality of stages connected to one another, wherein each of the plurality of stages receives a first driving voltage as an input and transmits the first driving voltage using an output signal of a previous stage according to a first scan start signal or a first driving order to control an output of a clock signal or an inverted clock signal, and wherein the first driving voltage is at a high state for a partial time of one frame and at a low state for the remaining time of the frame at the first driving order. By using the method, a partial driving can be performed, and accordingly power consumption of the shift register can be reduced.

This application claims priority to Korean Patent Application No. 10-2006-0064675, filed on Jul. 11, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a shift resister, a display device including the shift register, a method of driving a shift register, and a method of driving a display device.

(b) Description of the Related Art

Recently, flat panel display devices such as organic light emitting diode (“OLED”) display devices, plasma display panel (“PDP”) devices, and liquid crystal display (“LCD”) devices have been actively developed as substitutes for the heavy-weighted and large-sized cathode ray tube (CRT) display devices.

The PDP device is a device for displaying characters or images by using plasma generated from gas discharge, and the OLED device is a device for displaying characters or images by using electroluminescence of specific organic materials or specific polymers. The LCD device is a device for displaying characters or images by applying an electric field to a liquid crystal layer disposed between two panels and controlling a strength of the electric field to adjust the transmittance of light passing through the liquid crystal layer.

Among the display devices explained above, the liquid crystal display device includes a pixel including a switching device, a display panel including display signal lines, a gate driver for turning on/off the switching device of the pixel by sending out a gate on/off voltage to gate lines among the display signal lines, and a data driver for sending out a data voltage to data lines among the display signal lines to apply the data voltage to the pixel through the turned-on switching device.

In a large-sized display device, along with a middle or small sized display device, the gate driver formed by a same process for forming the switching device of the pixel may be integrated on the display panel.

The gate driver, substantially as a shift register, includes a plurality of stages which are connected to each other and linear aligned. A first stage receives a scan start signal and outputs a gate output, simultaneously with sending out a carry output to the next stage to sequentially generate a gate output. The gate output may be used as the carry output.

A bidirectional driving method has been developed for the middle or small sized display device in which an original image can be seen in a right or an original orientation even when the display panel unit is rotated 180°.

The bidirectional driving method includes are a mode in which gate signals are sequentially generated from a first stage to a last stage (hereinafter, referred to as a forward direction mode) and a mode in which gate signals are sequentially generated from the last stage to the first stage (hereinafter, referred to as a backward direction mode).

However, if all of the stages are operated in a case when only a portion of a screen of the display device is used for display, such as displaying a clock, for example, unnecessary power consumption in driving the entire screen of the display device may result.

Accordingly, a technical aspect of the present invention is to provide a device for driving a display device and a display device capable of driving a portion of a screen.

### BRIEF SUMMARY OF THE INVENTION

The present invention has been made in an effort to provide a shift register, a display device including the shift register, a method of driving a shift register, and a method of driving a display device having an aspect, feature and advantage of being capable of driving only a portion of a screen. An exemplary embodiment of the present invention provides a shift register including a plurality of stages connected to one another, wherein each of the plurality of stages receives the first driving voltage as an input and transmits the first driving voltage based on an output signal of a previous stage according to the first scan start signal or a first driving order to control an output of a clock signal or an inverted clock signal.

In the above exemplary embodiment, in the first driving order, the first driving voltage may be at a high state for a partial time of one frame and at a low state for the remaining time of the frame. In addition, each of the plurality of stages may receive a second driving voltage as an input and transmit the second driving voltage based on the output signal of the previous stage according to the second scan start signal or a second driving order to control an output of the clock signal or the inverted clock signal.

In addition, the second driving voltage may be at a low state for one frame when, in the first driving order, the first driving voltage is at a high state for a partial time of one frame and in a low state for the remaining time of the frame, and the first driving voltage may be in a high state for one frame when, in the first driving order, the second driving voltage is in a high state for a partial time of one frame and in a low state for the remaining time of the frame.

In another exemplary embodiment of the present invention, a display device may use the shift register as a driver. An exemplary embodiment of a display device includes: a gate driver including a shift register including a plurality of stages connected to one another, wherein each of the plurality of stages receives the first driving voltage as an input and transmits the first driving voltage based on an output signal of a previous stage according to a first scan start signal or a first driving order to control an output of a clock signal or an inverted clock signal.

Another exemplary embodiment of the present invention provides a method of driving a shift register including a plurality of stages connected to one another, the method includes: inputting a driving voltage to the plurality of stages; transmitting the driving voltage based on a scan start signal or an output of a previous stage; outputting a clock signal or an inverted clock signal as an output signal by means of the driving voltage; and inputting the output signal to the previous stage and a next stage.

In the above described exemplary embodiment, the driving voltage may be at a high state for a partial time of one frame and at a low state for the remaining time of the one frame.

Yet another exemplary embodiment of the present invention provides a method of driving a display device including a plurality of stages connected to a respective gate line, the method including: inputting a driving voltage to the plurality of stages; transmitting the driving voltage based on a scan start signal or an output of a previous stage; outputting a clock signal or an inverted clock signal as an output signal by means of the driving voltage; and applying the output signal to the gate line simultaneously with inputting the output signal to the previous stage and a next stage.

In the present exemplary embodiment, the driving voltage may be in a high state for a partial time of one frame and in a low state for the remaining time of the frame.

In addition, the driving voltage may be in a high state for at least one frame of a plurality of frames.

In addition, the plurality of stages may be integrated on the display device

### BRIEF DESCRIPTION OF THE DRAWINGS

The accompanying drawings briefly described below illustrate exemplary embodiments of the present invention and, together with the description thereof, serve to explain the principles of the present invention, in which:

FIG. 1 is a block diagram of a liquid crystal display according to an exemplary embodiment of the present invention;

FIG. 2 is an equivalent circuit diagram for a pixel of a liquid crystal display according to an exemplary embodiment of the present invention;

FIG. 3 is a schematic block diagram of a gate driver according to an exemplary embodiment of the present invention;

FIG. 4 is a circuit diagram of an exemplary embodiment of a j-th stage of a shift register for driving a gate in FIG. 3;

FIG. 5 is a diagram of signal waveforms for driving the entire gate driver in FIG. 3; and

FIG. 6 is a diagram of signal waveforms for driving a portion of the gate driver in FIG. 3.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described in more detail with reference to the accompanying drawings.

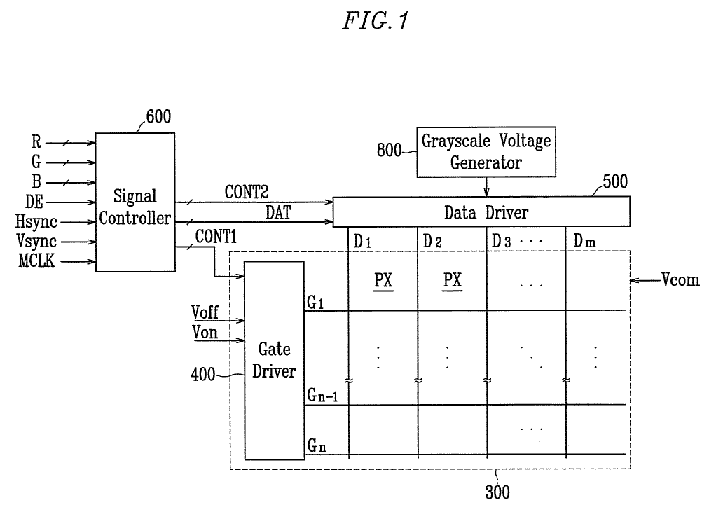

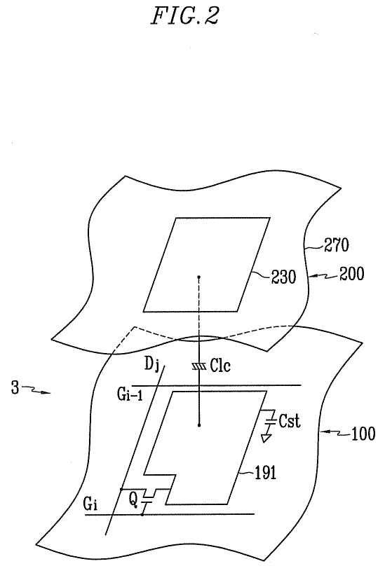

A display device according to an exemplary embodiment of the present invention will be explained first in more detail with reference to FIGS. 1 and 2.

FIG. 1 is a block diagram of a liquid crystal display according to an exemplary embodiment of the present invention FIG. 2 is an equivalent circuit diagram for a pixel of a liquid crystal display according to an exemplary embodiment of the present invention.

As shown in FIG. 1, a liquid crystal display according to an exemplary embodiment of the present invention includes a liquid crystal panel assembly 300 (shown with a dashed line), gate and drivers 400 and 500 which are connected to the liquid crystal panel assembly 300, a grayscale voltage generator 800 connected to the data driver 500, and a signal controller 600 which controls the above-described circuit elements.

The liquid crystal panel assembly 300 includes a plurality of signal lines G₁ to Gₙ and D₁ to Dₘ and a plurality of pixels PX connected to the plurality of signal lines and arranged in a matrix form, in terms of an equivalent circuit. The liquid crystal panel assembly 300 includes lower and upper display panels 100 and 200, respectively, facing each other and a liquid crystal layer 3 disposed therebetween as best seen with reference to FIG. 2.

The signal lines G₁ to Gₙ and D₁ to Dₘ include a plurality of gate lines G₁ to Gₙ for delivering gate signals (also referred to as scan signals) and a plurality of data lines D₁ to Dₘ for delivering data signals. The gate lines G₁ to Gₙ extend in an approximate row direction and are substantially parallel to each other, and the data lines D₁ to Dₘ extend in a column direction and are substantially parallel to each other, as illustrated in FIG. 1.

Each pixel PX, for example a pixel PX connected to an i-th gate line Gᵢ (where i=1, 2, n) and a j-th data line Dⱼ (where j=1, 2, m), includes a switching device Q connected to a signal line (Gᵢ Dⱼ), a liquid crystal capacitor Clc connected to the switching device Q, and a storage capacitor Cst. The storage capacitor Cst may be omitted if necessary in alternative exemplary embodiments.

The switching device Q is a device, such as a thin film transistor, having three terminals included in the lower display panel 100. The switching device Q includes a control terminal, and input terminal and an output terminal. The control terminal is connected to a gate line Gᵢ, the input terminal is connected to a data line Dⱼ, and the output terminal is connected to the liquid crystal capacitor Clc and the storage capacitor Cst.

The liquid crystal capacitor Clc has a pixel electrode 191 of the lower display panel 100 and a common electrode 270 of the upper display panel as two terminals, and the liquid crystal layer 3 between the two electrodes 191 and 270 functions as a dielectric. The pixel electrode 191 is connected to the switching device Q. The common electrode 270 is formed on a front facing side of the upper display panel 200, and a common voltage Vcom is applied to the common electrode 270. The common electrode 270 may be included in the lower display panel 100 differently from a case illustrated in FIG. 2, and in such a case, at least one of the two electrodes 191 and 270 may be formed in a shape of a line or a rod.

The storage capacitor Cst, which supports the function of the liquid crystal capacitor Clc, is formed by overlapping a separate signal line (not shown) included in the lower display panel 100 and the pixel electrode 191 with an insulator interposed therebetween. A predetermined voltage such as the common voltage Vcom is applied to the separate signal line. However, the storage capacitor Cst may be formed by overlapping the pixel electrode 191 and a previous gate line gate line Gᵢ₋₁ with an insulator interposed therebetween.

For color display, each pixel PX may uniquely display one of plurality of primary colors, which is referred to as spatial division, or alternatively, each of the pixels may display one of the primary colors at a time, which is referred to as temporal division. A desired color can be recognized by a spatial or temporal sum of the primary colors. An example of a plurality of primary colors includes three primary colors including red, green, and blue colors, for example, but is not limited thereto.

FIG. 2 is an example of spatial division. As shown in FIG. 2, each of the pixels PX includes a color filter 230 representing one of the primary colors and is disposed in a region of the upper display panel 200 corresponding to a pixel electrode 191. Unlike FIG. 2, the color filter 230 may be formed above or under the pixel electrode 191 of the lower display panel 100.

At least one polarizer (not shown) for polarizing light is attached to an outer surface of the liquid crystal panel assembly 300.

Referring again to FIG. 1, the grayscale voltage generator 800 generates two grayscale voltages sets (or reference grayscale voltage sets) which are related to transmittance of the pixels PX. Between the two grayscale voltage sets, one grayscale voltage set has a positive value with respect to the common voltage Vcom, and the other grayscale voltage has a negative value with respect to the common voltage Vcom.

The gate driver 400 may integrated on the liquid crystal panel assembly 300 and connected to the gate lines G₁ to Gₙ. The gate driver 400 applies a gate signal including a combination of a gate-on voltage Von and a gate-off voltage Voff to the gate lines G₁ to Gₙ.

The data driver 500 is connected to the data lines D₁ to Dₘ of the liquid crystal panel assembly 300. The data driver 500 selects a grayscale voltage generated by the grayscale voltage generator 800 and applies the selected grayscale voltage to the data lines D₁ to Dₘ as data signals.

Alternatively, in a case where the grayscale voltage generator 800 generates only a predetermined number of the reference grayscale voltages instead of all the grayscale voltages, the data driver 500 may generate the grayscale voltages for all of the grayscale voltages by dividing the reference grayscale voltages and select the data signals among the generated grayscale voltages.

The signal controller 600 controls the gate driver 400, the data driver 500, and other like drivers.

Each of the drivers 500, 600 and 800 except the gate driver 400 may be installed directly on the liquid crystal panel assembly 300 in the form of at least one integrated circuit chip. Alternatively, each of the drivers 500, 600 and 800 may be installed on a flexible printed circuit film (not shown) to be attached to the liquid crystal panel assembly 300 in a form of a tape carrier package (“TCP”) or installed on a separate printed circuit board (not shown). Alternately, the drivers 500, 600 and 800 may be integrated on the liquid crystal panel assembly 300 together with the signal lines G₁ to Gₙ and D₁ to Dₘ, the thin film transistor switching device, and the like. In addition, the drivers 500, 600 and 800 may be integrated as a single chip. And in this case, at least one of the drivers 500, 600 and 800 or at least one circuit element forming the drivers 500, 600, and 800 may be formed outside the single chip.

The operation of the liquid crystal display device illustrated in FIGS. 1 and 2 will now be explained in more detail.

The signal controller 600 receives input image signals R, G and B and input control signals for controlling display of the input image signals R, G and B from an external graphic controller (not shown). Examples of the input control signals include a vertical synchronization signal Vsync, a horizontal synchronization signal Hsync, a main clock signal MCLK and a data enable signal DE.

The signal controller 600 processes the input image signals R, G and B according to an operating condition of the liquid crystal panel assembly 300 based on the input image signals R, G and B and the input control signals to generate a gate control signal CONT1, a data control signal CONT2 and the like, and thereafter, sends out the generated data control signal CONT1 to the gate driver 400 and the generated data control signal CONT2 and the processed image signal DAT to the data driver 500.

The gate control signal CONT1 includes scan start signals ST1 and ST2 for indicating scan start and at least one clock signal CLK1 or CLK2 for controlling an output period of the gate-on voltage Von. The gate control signal CONT1 may further include an output enable signal OE for limiting a duration time of the gate-on voltage Von. In addition, the gate control signal CONT1 may include forward and backward driving voltages Vfwd and Vbwd, respectively, for the bidirectional driving and may include one of the forward and backward driving voltages Vfwd and Vbwd for a unidirectional driving.

The data control signal CONT2 includes a horizontal synchronization start signal STH for indicating initiation of data transmission for a row of pixels PX, a load signal LOAD for requesting to apply data signals to the data lines D₁ to Dₘ, and a data clock signal HCLK. The data control signal CONT2 may further include a reverse signal RVS for inverting a voltage polarity of the data signal with respect to the common voltage Vcom (hereinafter, the voltage polarity of the data signal with respect to the common voltage is abbreviated to “a polarity of the data signal”).

The data driver 500 receives digital image signals DAT for a row of pixels PX according to the data control signal CONT2 transmitted from the signal controller 600 and selects a grayscale voltage corresponding to each digital image signal DAT to convert the digital image signals DAT into analog data signals. Thereafter the data driver 500 applies the converted analog data signals to corresponding data lines D₁ to Dₘ.

The gate driver 400 applies a gate-on voltage Von to the gate lines G₁ to Gₙ according to the gate control signal CONT1 transmitted from the signal controller 600 to turn-on switching devices Q connected to the gate lines G₁ to Gₙ. Then, the data signals applied to the data lines D₁ to Dₘ are applied to corresponding pixels PX through the turned-on switching devices Q.

A difference between a voltage of the data signal applied to the pixels PX and the common voltage Vcom appears to be a charged voltage of the liquid crystal capacitor Clc, that is, a pixel voltage. Alignment of the liquid crystal molecules varies according to the magnitude of the pixel voltage to change the polarization of light passing through the liquid crystal layer 3. The transmittance of the light is changed by a polarizer (not shown) attached to the liquid crystal panel assembly 300 according to the change in the polarization.

In units of one horizontal period, which may be written as 1H and is the same as one period of the horizontal synchronization signal Hsync and the data enable signal DE, the aforementioned operations are repetitively performed to sequentially apply the gate-on voltages Von to all of the gate lines G₁ to Gₙ, so that the data signals are applied to all of the pixels PX. As a result, one frame of an image is displayed.

When one frame ends, the next frame starts, and a state of the reverse signal RVS applied to the data driver 500 is controlled, so that the polarity of the data signal applied to each of the pixels is opposite to the polarity in the previous frame (frame inversion). At this time, even in one frame, according to the characteristics of the reverse signals RVS, the polarity of the data signal flowing through the one data line may be inverted (row inversion and dot inversion). In addition, the polarities of the data signals applied to the one pixel row may be different from each other (column inversion and dot inversion).

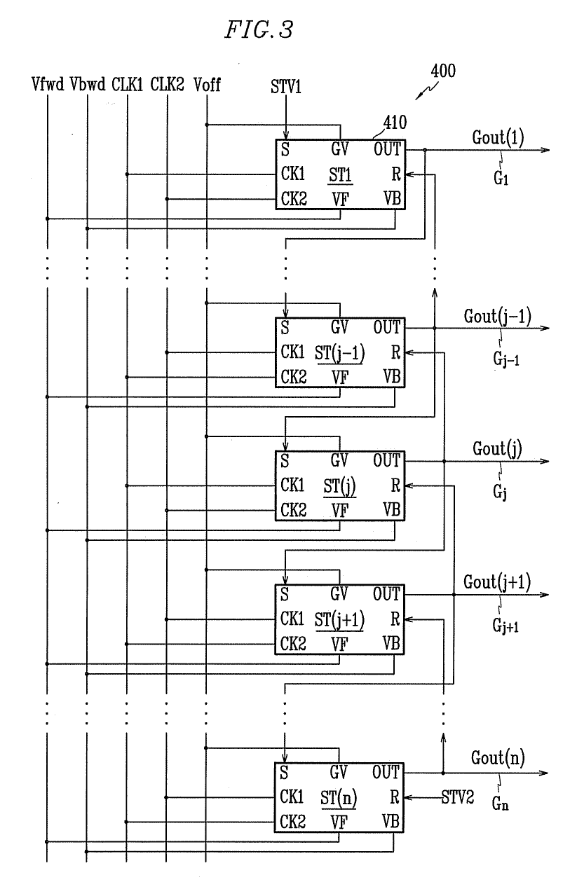

Now, a liquid crystal display device according to an exemplary embodiment of the present invention will be described in more detail with reference to FIGS. 3 to 6.

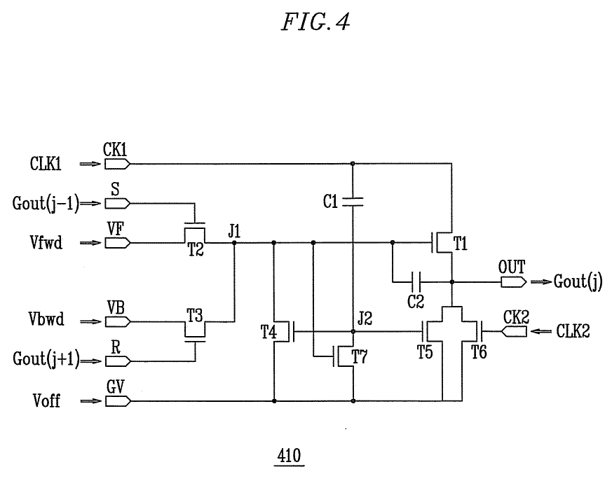

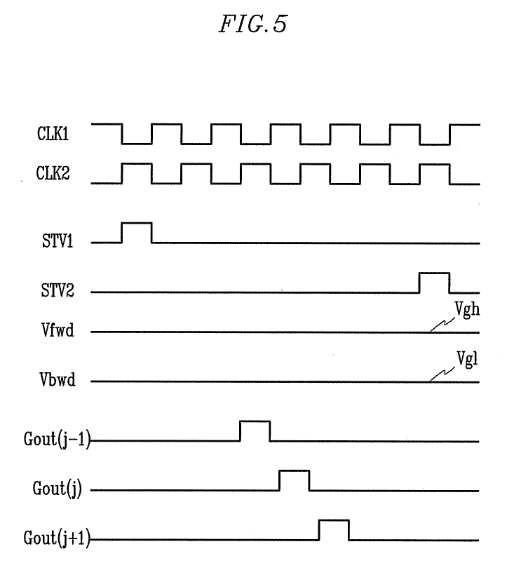

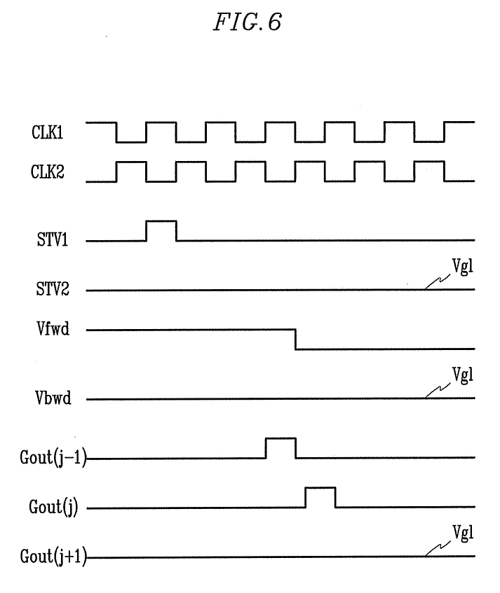

FIG. 3 is a schematic block diagram of a gate driver according to an exemplary embodiment of the present invention. FIG. 4 is an exemplary circuit diagram of a j-th stage of a shift register for driving a gate in FIG. 3 FIGS. 5 and 6 are diagrams of signal waveforms of the gate driver in FIG. 3.

For convenience of explanation, each magnitude of the forward and backward driving voltages Vfwd and Vbwd, respectively, and the voltages of the clock signals CLK1 and CLK2 corresponding to a high level is the same as that of the gate-on voltage Von and referred to as a high voltage, while each of the magnitudes of the voltages corresponding to a low level is the same as that of the gate-off voltage Voff and referred to as a low voltage.

The gate driver 400 illustrated in FIG. 3 is a shift register including a plurality of stages 410 connected to respective gate lines G₁ to Gₙ. A scan start signal STV, clock signals CLK1 and CLK2, a gate-off voltage Voff, and forward and backward driving voltages Vfwd and Vbwd are input to the gate driver 400.

Each stage 410 has a set port S, a reset port R, a gate voltage port GV, a gate output port OUT, clock ports CK1 and CK2, and forward and backward voltage ports VF and VB.

In each stage 410, for example, a j-th stage ST(j), the set port S is applied with a gate output of a previous stage ST(j−1), that is, a gate output of the previous stage Gout(j−1), and the reset port R is applied with a gate output of a next stage ST(j+1, that is, a gate output of a next stage Gout(j+1). In addition, the clock ports CK1 and CK2 are respectively applied with the clock signals CLK1 and CLK2. The gate output port OUT sends out a gate output Gout(j) to a gate line Gⱼ and previous and next stages ST(j−1) and ST(j+1). Alternatively, a separate output port for sending out carry signals output to the previous and next stages ST(j−1) and ST(j+1) may be further included, and a buffer connected to the output port OUT may be further included.

In addition, forward and backward voltage ports VF and VB are applied with the forward and backward driving voltages Vfwd and Vbwd, respectively. At this time, when the liquid crystal display device is operated in a forward direction, the forward driving voltage Vfwd maintains the high voltage Vgh, while the backward driving voltage Vbwd maintains the low voltage Vgl. On the contrary, when the liquid crystal display device is operated in a backward direction, the backward driving voltage Vbwd maintains the high voltage Vgh, while the forward driving voltage Vfwd maintains the low voltage Vgl.

In sum, each stage 410 outputs a gate output in synchronization with the clock signals CLK1 and CLK2 based on the forward and backward driving voltages Vfwd and Vbwd, a gate output of a previous stage Gout(j−1), and a gate output of a next stage Gout(j+1).

However, a first stage ST1 of the shift register 400 receives the scan start signal STV1 instead of the gate output of the previous stage as an input, and the last stage ST(n) receives the scan start signal STV2 instead of the gate output of the next stage as an input. In other words, in the forward driving, the scan start signal STV1 is input first, while in the backward driving, the scan start signal STV2 is input first. The scan start signals STV1 and STV2 respectively have a width of 1H and are signals having a period of one frame which are respectively input at the start and the end of one frame.

As best illustrated with reference to FIG. 5, the clock signals CLK1 and CLK2 have a duty ratio of 50%, a period of 2H and a phase difference of 180° between each other. At this time, for example, when the clock ports CK1 and CK2 of the j-th state ST(j) are applied with the clock signals CLK1 and CLK2, respectively, the clock ports CK1 and CK2 of the (j−1)-th and (j+1)-th stages ST(j−1) and ST (j+1) adjacent to the j-th stage ST(j) are applied with the clock signals CLK2 and CLK1, respectively, as illustrated in FIG. 3.

Referring to FIG. 4, each stage of the gate driver 400 according to an exemplary embodiment of the present invention, for example the j-th stage, includes at least one NMOS transistor T1 to T7 and capacitors C1 and C2. However, a PMOS transistor may be used instead of the NMOS transistor in alternative exemplary embodiments. In addition, the capacitors C1 and C2 may be a parasitic capacitance formed between drain and source electrodes during practical manufacturing processes.

The transistor T2 is connected to the set port S and outputs the forward driving voltage Vfwd to a contact point J1.

The transistor T3 is connected to the reset port R and outputs the backward driving voltage Vbwd to the contact point J1.

The control ports of the transistors T4 and T5 are commonly connected to a contact point J2 and transmit the gate-off voltage Voff to the contact point J1 and an output port OUT, respectively.

The transistors T6 and T7 are respectively connected to the clock port CK2 and the contact point J1 and transmit the gate-off voltage to the contact point J2 and the output port OUT, respectively.

A control terminal of the transistor T1 is connected to the contact point J1, and the transistor T1 outputs the clock signal CLK1 to the output port OUT.

The capacitor C1 is connected between the clock port CK1 and the contact point J2, and the capacitor C2 is connected between the contact point J1 and the output port OUT.

Operations of a shift register illustrated in FIG. 4 will now be explained for the j-th stage as an example with reference to FIGS. 5 and 6.

Here, FIG. 5 is a diagram of signal waveforms for an overall driving, while FIG. 6 is a diagram of signal waveforms for a partial driving. And, the forward driving and backward driving will be explained as an example. Accordingly, as explained above, the forward driving voltage Vfwd is the high voltage Vgh, and the backward driving voltage Vbwd is the low voltage Vgl.

When the j-th stage ST(j) generates a gate output in synchronization with the clock signal CLK1, the previous and next stages ST(j−1) and ST(J+1) generate gate outputs in synchronization with the clock signal CLK2.

First, when the clock signal CLK2 and the gate output of the previous stage Gout(j−1) are at the high level, the transistors T2 and T6 are turned on. Then, the transistor T2 transmits the high voltage Vgh to the contact point J1 to turn on the transistors T1 and T7. As a result, the transistors T7 and T6 transmit the low voltage Vgl to the contact point J2 and the output port OUT, respectively. In addition, the transistor T7 is turned on to output the clock signal CLK1 to the output port OUT. At this time, the clock signal CLK1 is at the low voltage Vgl, and accordingly the gate output Gout(j) maintains the low voltage. At the same time, the capacitor C2 is charged up to a voltage having a magnitude corresponding to a difference of the high voltage Vgh and the low voltage Vgl.

At this time, since the gate output of the next stage Gout(j+1) is at the low level, an input to the reset port R is at the low level, too. Accordingly, the transistors T4 and T5 of which control terminals are connected to the contact point J2 are turned off.

Thereafter, when the clock signal CLK1 is at the high level, and the clock signal CLK2 is at the low level, the transistor T6 is turned on. Accordingly, the output port OUT is blocked from the gate-off voltage Voff, and at the same time the output port OUT is connected to the clock signal CLK1 to transmit the high voltage Vgh as the gate output Gout(j). At this time, the capacitor C1 is charged up to a voltage corresponding to a difference between the high voltage Vgh and the low voltage Vgl. On the other hand, a voltage of one port, which is the contact point J1, of the capacitor C2 increases further by the high voltage Vgh.

Thereafter, when the clock signal CLK1 is at the low level, the contact point J1 is in a floating state thereby maintaining the previous voltage, so that the transistor is maintained to be turned-on, and the output port OUT outputs the clock signal CLK1 which is at the low level. In addition, the transistor T7 is also maintained to be turned-on, and accordingly the contact point J2 maintains the low voltage Vgl.

Next, when the gate output of the next stage Gout(j+1) is in the high level, the transistor T3 is turned-on to transmit the low voltage Vgl to the contact point J1. As a result, the transistor T1 is turned-off to block the connection between the clock signal CLK1 and the output port OUT.

At the same time, the clock signal CLK2 is at the high level, and accordingly the transistor T6 is turned-on to connect the output port OUT and the gate-off voltage Voff, so that the output port OUT continues to send out the low voltage. In addition, the transistor T7 is turned-off, and accordingly the contact point J2 is in a floating state to maintain the low voltage Vgl, which is the previous voltage.

Thereafter, when the gate output of the next stage Gout(j+1) and the clock signal CLK2 are at the low level, the contact points J1 and J2 are in a floating status maintaining the previous voltages. At this time, since one terminal of the capacitor C1 is connected to the clock signal CLK1, a voltage of the contact point J2 which is in a floating status varies according to a level of the clock signal CLK1.

Thereafter, the output port OUT is connected to the gate-off voltage Voff through the transistor T5 when the voltage of the contact point J2 is the high voltage, that is the clock signal CLK1 at in the high level. On the other hand, when the clock signal CLK2 is at the high level, the output port OUT is connected to the gate-off voltage through the transistor T6.

After the gate outputs of stages from the first stage ST1 to the last stage ST(n) are generated in accordance with the aforementioned method, the scan start signal STV2 is input to the reset port R of the last stage ST(n) to complete operations for one frame.

So far, the whole driving in which all of the stages ST1 to ST(n) are operated has been explained, and a partial driving in which only a portion of the stages are operated will now be explained.

For example, when j stages, that is a potion of the total n stages are driven in a forward driving, after the gate output of the (j−1)-th stage Gout(j−1) is generated, the forward driving voltage is changed from the high voltage Vgh to the low voltage Vgl.

Accordingly, as explained above, the j-th stage generates the gate output Gout(j) by performing the aforementioned operations when the gate output of the previous stage Gout(j−1) is input.

The gate output Gout(j) is input to the previous and next stages ST(j−1) and ST(j+1), respectively. At this time, in order to turn the transistor T1 on, the transistor T2 of the next stage ST(j+1) should be turned on and transmit the high voltage Vgh to the contact point J1. However, at a time when the gate output Gout(j) is generated, since the forward driving voltage Vfwd is the low voltage Vgl, the low voltage Vgl cannot be transmitted to the contact point J1 for turning the transistor T1 on. And accordingly, the (j+1)-th gate output Gout(j+1) cannot be generated.

To summarize, in order to drive up to the j-th stage ST(j), the magnitude of the forward driving voltage Vfwd should be changed from the high voltage to the low voltage right after the previous stage ST(j−1) generates the gate output Gout(j−1).

At this time, the gate lines connected to stages ST(j+1) to ST(n), which are not operated, are applied with only the gate-off voltage Voff. This is because, as explained above, the output port OUT continuously transmits the gate-off voltage due to the transistor T5 which is connected to the contact point J2 and the transistor T6 which is connected to the clock signal CLK2.

As a result, since the switching device Q of the pixel PX is continuously applied with a direct-current (“DC”) voltage, the switching device Q may deteriorate, for example a threshold voltage of the switching device Q is changed, or the image quality of a display device including the pixel PX may worsen. To prevent this from happening, an alternating-current (“AC”) may be applied to the switching device Q of the pixel PX by operating all of the stages for a predetermined number of frames, for example ten frames, in an operational mode of sixty frames per second to apply the gate-on voltage Von to the switching device Q of the pixel PX. In other words, by units of six frames, all of the stages are driven for the first frame, and a portion, less than of all of the stages are driven for the remaining five frames. As explained above, a partial driving can be performed by changing the magnitude of the forward driving voltage Vfwd from the high voltage Vgh to the low voltage Vgl after the previous stage generates the gate output, thereby reducing power consumption of the device.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A shift register including a plurality of stages connected to one another,
wherein each of the plurality of stages receives the first driving voltage as an input and transmits the first driving voltage based on an output signal of a previous stage according to a first scan start signal or a first driving order to control an output of a clock signal or an inverted clock signal.

2. The shift register of claim 1, wherein in the first driving order, the first driving voltage is at a high state for a partial time of one frame and at a low state for the remaining time of the frame.

3. The shift register of claim 1, wherein each of the plurality of stages receives the second driving voltage as an input and transmits the second driving voltage based on the output signal of the previous stage according to a second scan start signal or a second driving order to control an output of the clock signal or the inverted clock signal.

4. The shift register of claim 3, wherein the second driving voltage is in a low state for one frame when, in the first driving order, the first driving voltage is at a high state for a partial time of one frame and at a low state for the remaining time of the frame, and
wherein the first driving voltage is at a high state for one frame when, in the first driving order, the second driving voltage is at a high state for a partial time of one frame and at a low state for the remaining time of the frame.

5. A display device comprising:
a gate driver including a shift register including a plurality of stages connected to one another,
wherein each of the plurality of stages receives the first driving voltage as an input and transmits the first driving voltage based on an output signal of a previous stage according to a first scan start signal or a first driving order to control an output of a clock signal or an inverted clock signal.

6. The display device of claim 5, wherein in the first driving order, the first driving voltage is at a high state for a partial time of one frame and at a low state for the remaining time of the frame.

7. The display device of claim 5, wherein each of the plurality of stages receives the second driving voltage as an input and transmits the second driving voltage based on the output signal of the previous stage according to a second scan start signal or a second driving order to control an output of the clock signal or the inverted clock signal.

8. The display device of claim 7, wherein the second driving voltage is at a low state for one frame when, in the first driving order, the first driving voltage is at a high state for a partial time of one frame and at a low state for the remaining time of the frame, and
wherein the first driving voltage is at a high state for one frame when, in the first driving order, the second driving voltage is at a high state for a partial time of one frame and in a low state for the remaining time of the frame.

9. A method of driving a shift register including a plurality of stages connected to one another, the method comprising:
inputting a driving voltage to the plurality of stages;
transmitting the driving voltage based on a scan start signal or an output of a previous stage;
outputting a clock signal or an inverted clock signal as an output signal by means of the driving voltage; and
inputting the output signal to the previous stage and a next stage.

10. The method of claim 9, wherein:
the driving voltage is at a high state for a partial time of one frame and at a low state for the remaining time of the frame.

11. A method of driving a display device including a plurality of stages connected a gate line, respectively, the method comprising:
inputting a driving voltage to the plurality of stages;
transmitting the driving voltage based on a scan start signal or an output of a previous stage;
outputting a clock signal or an inverted clock signal as an output signal by means of the driving voltage; and
applying the output signal to the gate line simultaneously with inputting the output signal to the previous stage and a next stage.

12. The method of claim 11, wherein:
the driving voltage is at a high state for a partial time of one frame and at a low state for the remaining time of the frame.

13. The method of claim 12, wherein:
the driving voltage is at a high state for at least one frame of a plurality of frames.

14. The method of claim 12, wherein:
the plurality of stages are integrated on the display device.
